(19) United States
(12) Patent Application Publication
(10) Pub. No.: US 2008/0065447 A1
(43) Pub. Date: Mar. 13, 2008

(54) Interactive and Incremental Event Scheduling

(75) Inventors: Stephen A. Evanchik, Malden, MA (US); Alister Lewis-Bowen, Cambridge, MA (US); Louis M. Weitzman, Brookline, MA (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/467,999

(22) Filed: Aug. 29, 2006

(51) Int. Cl. G05B 19/418

(52) U.S. Cl. 705/8

(57) ABSTRACT

A computer event schedule developer interactively schedules agenda items for an event such as a conference. A user is prompted to select event agenda items for scheduling for the event via a GUI interface. For each agenda item selected, the user is prompted to enter agenda schedule information for the corresponding agenda item such as time and location of the agenda item. The resulting event schedule is displayed to potential event attendees. Separately, meta-data about each agenda item is provided via a prompting view.

### FIELD OF THE INVENTION

The present invention is related to computerized calendaring and more particularly to scheduling of events.

### BACKGROUND OF THE INVENTION

Current scheduling tools are difficult to use in that they are typically sequential and don't work well when only partial information is available. Typical schedulers work in a step-by-step sequence of adding items to a list to create the complete schedule. This linear process is limited and not desirable when some of the information is missing.

US Patent Application No. 20050125278A1: “Method and apparatus for queue-based automated staff scheduling” (Vajracharua et. al) filed Dec. 09, 2004 and incorporated herein by reference provides a queue-based scheduling system, which comprises an automated staff scheduling computer program that is highly flexible in enforcing scheduling rules. This flexibility comes from the ability to Define conditional and unconditional rules, Rank the rules/requests in varying priority as represented by a numeric value assigned to each rule/request and specify rules both per individual and per group. These three abilities synergistically produce an automatic scheduling system that can enforce a wide variety of scheduling rules and requirements seen in actual staff scheduling situations. Furthermore, all these abilities rely on using a queue per scheduled assignment to hold requests and rules.

The application of Vajracharua provides an automatic highly flexible queue-based scheduling system, the flexibility is in enforcing scheduling rules. The flexibility comes from defining conditional and unconditional rules, ranking the rules and specifying rules for groups and individuals. A queue is used to hold the requests and rules. What is needed is a manual system not relying on scheduling rules permitting a user to choose how the schedule will be laid out.

US Patent Application No. 2003/0065544A1: “Method and system for performing dynamic scheduling” (Elzinga et. al) filed Sep. 28, 2003 and incorporated herein by reference provides a computerized system and method for optimizing a schedule that is filled with a plurality of events are disclosed. The system comprises means for defining a framework to serve as the schedule and means for determining an optimization value. The means for defining a framework populates the framework with the plurality of events, selected of the plurality of events being immutable. The means for determining an optimization value makes its determination based on the placement of the plurality of events after placement of the immutable events and it also determines whether the optimization value achieves a threshold best-solution value. If the threshold value is not reached, the framework defining means will perform event swapping to improve the optimization value.

The application of Elzinga teaches an optimization, what is needed is a method to allow the user to modify the schedule directly without placing restrictions on filling allotted time slots, permitting omitting events, and flexibility in scheduling event frequency.

### SUMMARY OF THE INVENTION

The present invention enables the creation of a schedule when information is missing and provides the tools to support the editor of the schedule with a general to specific set of tasks. The tasks begin by creating an object to describe the event being scheduled including the start and end dates of the event. Then schedule items (sessions of a conference) are created separately and/or in parallel. Each session item is created without regard to time or location. The next step is to create a sequence of group containers that will hold the session items. These groups can be not only in sequence but also in parallel, as in multi-track conference sessions. Once these group containers are constructed, the separately edited session items can be dropped into the groups. Once in the groups, session items times can be assigned. Support is given to this task so only beginning times need to be assigned (or end times) along with one boundary time (start or end time of the block). At any time the current state of the schedule will be displayable. Its display is refined as more information is provided.

It is therefore an object of the present invention to develop interactively, an event schedule for an event by presenting a GUI prompt view to a user comprising a list of one or more agenda items; presenting a GUI time block view comprising one or more time block views; responsive to a user first action, associating a first agenda item of the one or more agenda items with a first time block view of the one or more time block views; responsive to a user second action, entering first agenda schedule information into the first time block view; when more than one agenda items are to be scheduled, repeating steps b) through d) for each agenda item to be scheduled; and presenting to event schedule users, a session schedule resulting from the entered time block items and the entered time information, the session schedule comprising a chronological presentation of the entered time block items and the entered time information, the event schedule users comprising potential attendees of the event schedule

It is a further object of the invention to provide first agenda schedule information comprising first agenda location information consisting of a location for presenting the first agenda item associated with the first time block view, the location for presenting consisting of any one of a room, a building, a city, a state, a country or an electronic meeting virtual location such as a Web page of the world wide web.

It is yet another object of the invention to provide the first agenda schedule information comprising first agenda time information consisting of a time for presenting the first agenda item associated with the first time block view, the time for presenting consisting of any one of a time-of-day, a day, a month or a year.

It is still another object of the invention to provide the first time block view comprising widgets to perform an action, the action consisting of any one of adding a second time block view, displaying a second time block view, removing the first time block view, clearing the first time block view or organizing a time for presenting the first agenda item. Widgets are graphical user interface (GUI) components with which a user interacts.

It is another object of the invention to present, in responsive to a user third action of selecting the organizing a time widget, time prompts for time for presenting the first agenda item associated with the first lock view are presented, the time prompts consisting of any one of a computer generated time slot, an indication that the entered first agenda schedule information includes an invalid time, an indication that the entered first agenda schedule information includes an invalid time duration or an indication that the entered first agenda schedule information includes time that conflicts with previously entered agenda schedule, the generated time slot consisting of any one of a start time, an end time or a duration.

It is a further object of the invention to present a GUI announcements view and responsive to a user third action, enter announcement information into the announcements view; and present to the event schedule users, the entered announcements in addition to the presented session schedule.

It is still another object of the invention to present to a creating user, an agenda item view for creating an agenda item, the agenda item view comprising GUI prompts for any one of an agenda item title, an agenda item type, an event identifier, an agenda item contact, an agenda item presenter, an abstract of the agenda item, a description of the agenda item, an electronic attachment widget, an attachment description, a special event requirement, a submit widget or a cancel widget.

It is yet another object of the invention to, responsive to input from the creating user, enter agenda item information meta-data into the agenda item view for creating an agenda item; associate the entered agenda item information meta-data with the event having the event identifier; and present information of the entered agenda item information to the user in the presented GUI prompt view of the event.

It is another object of the invention to prompt the user in the presented GUI time block view using information of the entered agenda item information.

It is a further object of the invention to enter the first agenda schedule information into the first time block view out of order with respect to agenda schedule information of other agenda items of other time block views.

It is another object of the invention to provide the GUI prompt view to a user comprising a list of one or more agenda items, the GUI time block view comprising one or more time block views and the GUI announcements view are presented in a single GUI view.

The above as well as additional objectives, features, and advantages of the present invention will become apparent in the following written description.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting a prior art computer system;

FIG. 2 is a diagram depicting a prior art network of computer systems;

FIGS. 3-7 depicts GUI views of the present invention;

FIG. 8 depicts a flow of an embodiment of the invention; and

FIG. 9 depicts a view of a GUI view for initializing the present invention.

### DETAILED DESCRIPTION OF THE INVENTION

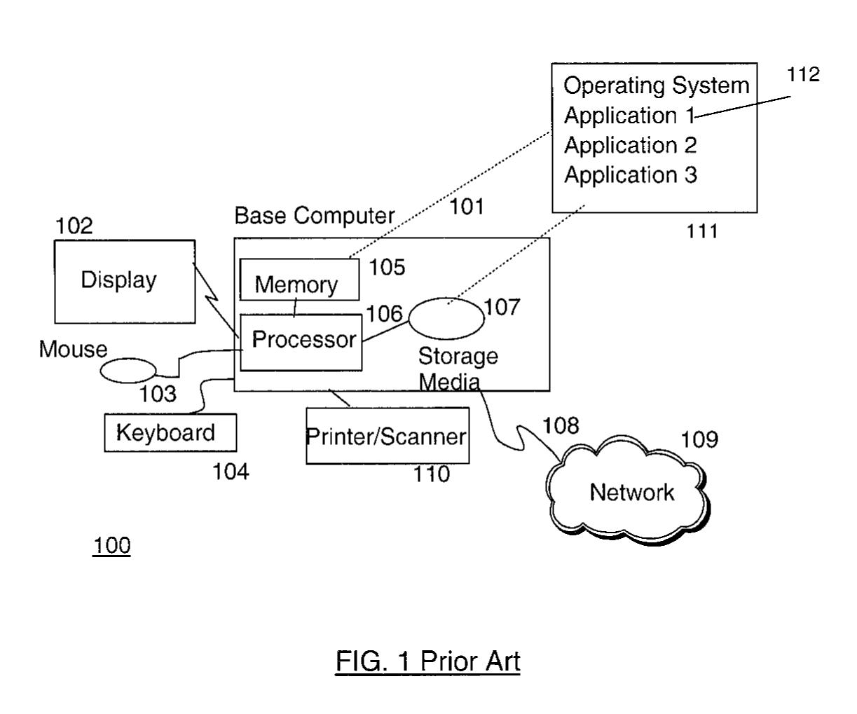

FIG. 1 illustrates a representative workstation or server hardware system in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating 108 with a network 109. Example network adapters are communications channels, token ring, Ethernet or modems. Alternatively, the workstation 101 may communicate using a wireless interface, such as a CDPD (cellular digital packet data) card. The workstation 101 may be associated with such other computers in a Local Area Network (LAN) or a wide Area Network (WAN), or the workstation 101 can be a client in a client/server arrangement with another computer, etc. All of these configurations, as well as the appropriate communications hardware and software, are known in the art.

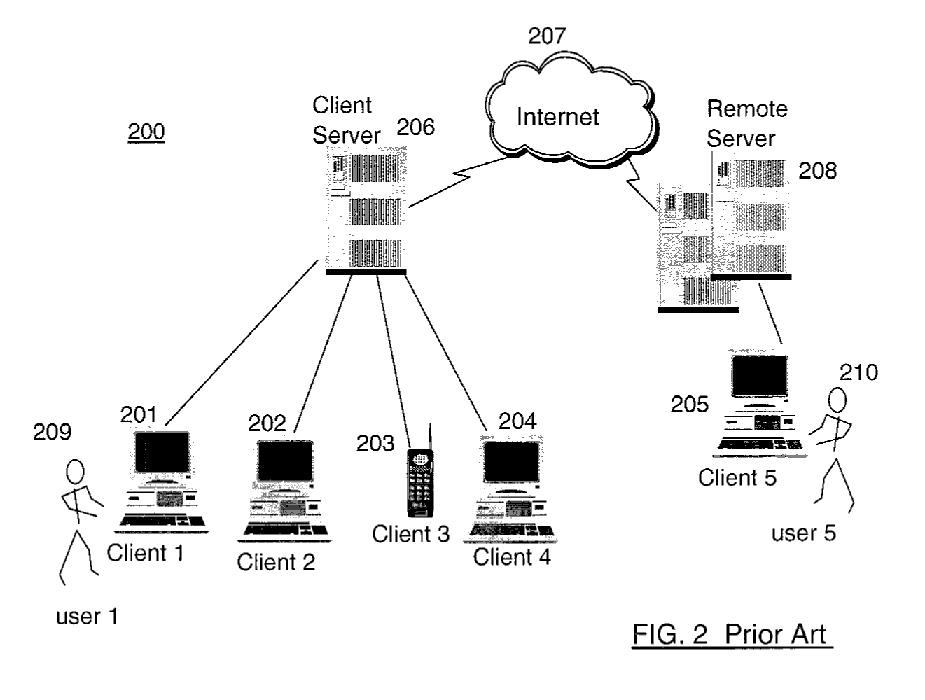

FIG. 2 illustrates a data processing network 200 in which the present invention may be practiced. The data processing network 200 may include a plurality of individual networks, such as a wireless network and a wired network, each of which may include a plurality of individual workstations 101 201 202 203 204. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository and may also be accessed directly from a workstation 205). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 201 202 203 204 using a communications link. The gateway computer may be implemented utilizing an IBM eServer zSeries® 900 Server available from IBM Corp.

Software programming code which embodies the present invention is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may he distributed on such media, or may be distributed to users 210 211 from the memory or storage of one computer system over a network to other computer systems for use by users of such other systems.

Alternatively, the programming code 111 may be embodied in the memory 105, and accessed by the processor 106 using the processor bus. Such programming code includes an operating system which controls the function and interaction of the various computer components and one or more application programs 112. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

The present invention may be practiced within a single computer or across a network of cooperating computers.

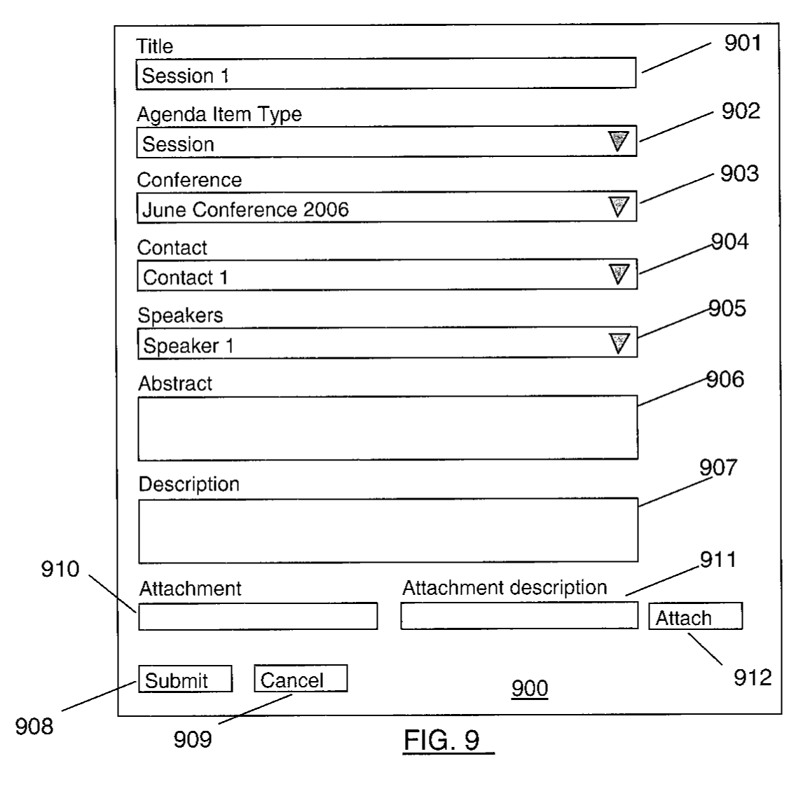

According to the present invention, an event scheduler provides a series of user friendly GUI prompt views for creating and scheduling events. Such a scheduler may be used for scheduling a variety of scheduled events such as a conference, an athletic event, an educational event or any other organized activity as is well known in the art. In one example, a conference is to be scheduled. An application program supporting the scheduling activity may be running in a client computer or on a server. An event organizer accesses the application and is presented with a first GUI screen such as the one shown in FIG. 9.

In one embodiment, the first GUI screen 900 presents a plurality of views 901-907, 910. One view 902 presents “Agenda Item Type” information whereby, a predetermined set of agenda types can be selected from a pull down widget associated with the window. In the example 900 the name of the event is selected from a pull down menu in a view 903 titled “Conference”. In the example, the selected name of the event is “June Conference 2006”. This is used in a later stage to filter agenda items and only show those items for an event when organizing that event.

Next the organizer selects an agenda item type “Session” since he knows that he wants to define a new session for the upcoming event “June Conference 2006”. The organizer enters a title of a session “Session 1” in a view 901 labeled “Title”. The Title preferably is indicative of the purpose of the session the organizer is creating.

Next, the organizer enters structured information about “Session 1” including information about one or more contacts 904 associated with session 1, and information about the presenters “Speakers” 905 for “Session 1”. Such information may be simply a name or it may include other information about the contacts or presenters such as telephone number, email address or the like. Optional fields are provided such as a view for an “Abstract” 906 for providing a brief description of the topic of Session 1, a “Description” view 907 to describe what will be accomplished at Session 1, and views 910-912 for attaching electronic documents. In one embodiment, the electronic location of the document (URL or File name) is entered in a view 910 by the organizer and an optional Attachment Title is provided 911 as well. Such documents to attach might be a registration form for providing information from an attendee to the presenter or material that might be useful in preparing for attendance at “Session 1”. The organizer may attach several documents using the attachment view 910 911 whereby he enters each attachment by selecting the attach button 912 which brings up a dialog to specify the attached file.

When the organizer has finished providing the information about Session 1, he submits the information to the application by selecting a submit 908 and proceeds to enter more sessions as needed.

The organizer similarly enters information about other “Agenda Types” such as Meals and Announcements.

It should be appreciated that the GUI screens are illustrative in order to teach the invention. A variety of screens may be employed consistent with the teaching of the invention by one of ordinary skill in the art.

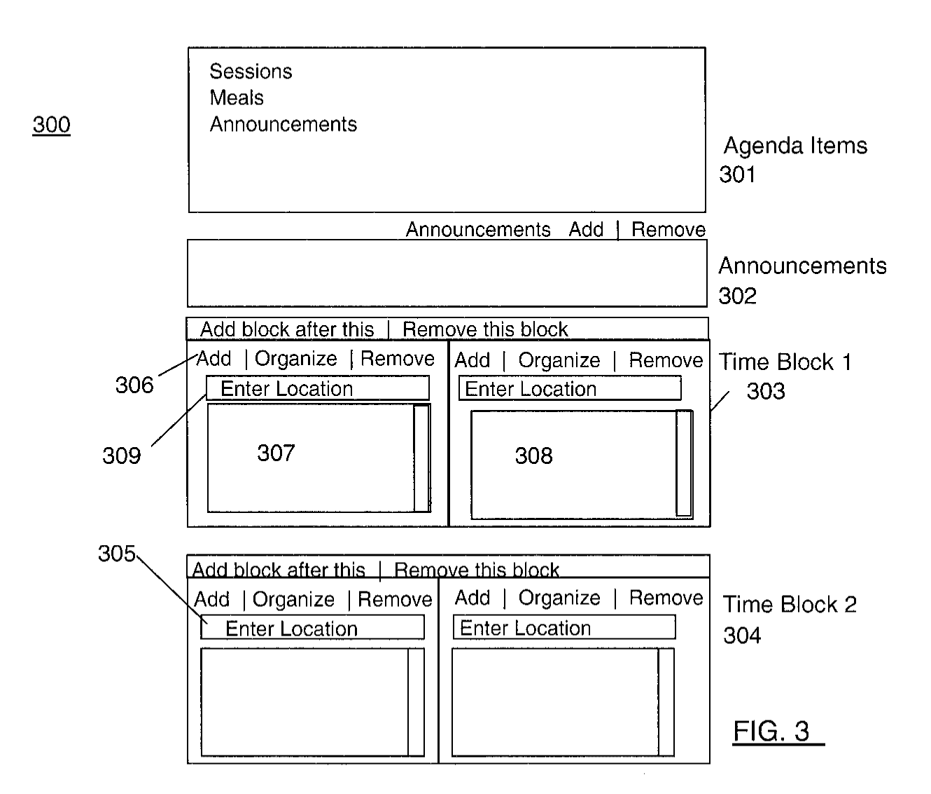

FIG. 3 illustrates an example initial blank form for constructing an agenda. The GUI form 300 is created by the application based on the information provided by the organizer previously described in FIG. 9. All agenda items are presented according to their type in the first widget (301). Initially the form is empty and only shows the category types, e.g., Sessions, Meals, and Announcements. The second GUI form (302) is used to place other information (such as announcements) that is not to be depicted as scheduled items. In addition, there can be a GUI form for the placement of other session information at the end of the blocks (not shown). Then, a sequence of time blocks is presented (303, 304). Each time block may have multiple tracks (307, 308), or simultaneous sessions that are presented in the same horizontal region. Additional tracks can be added to or removed from a block. Additional widgets for this action are not shown but could be represented as a button or clickable text string. In some instances, an agenda may restrict the number of simultaneous sessions so the user cannot add or remove them. Each track within the time block may have a location specified (309) by the user or the location can remain empty inheriting its location from the previous time block's track. Only 2 time blocks are shown but more time blocks can be added or existing ones may be removed using the commands at the top of a time block (305). Commands for the tracks allow the user to add, organize or remove elements in the track (306).

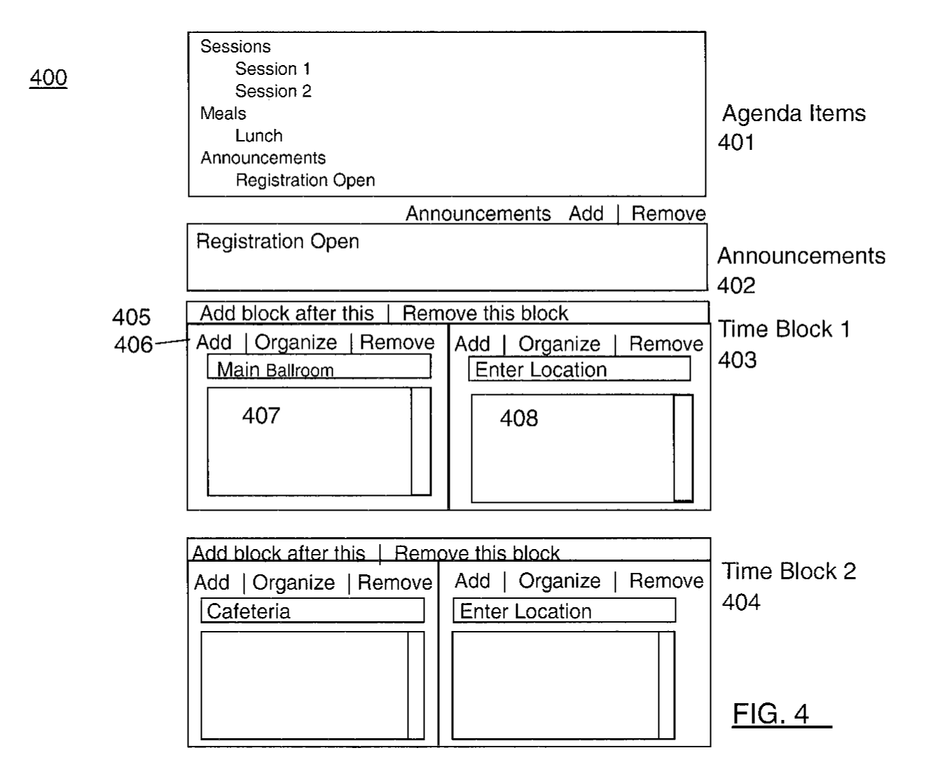

FIG. 4 illustrates the agenda items have been defined and are available for selection in the first form (401). The user selects them and then adds them to the desired time block track (407 or 408) using the add command in 406. In the example, 3 agenda items have been created 401. “Session 1” and “Session 2” items have been created for agenda type “Sessions”. “Lunch” item has been created for agenda type “Meals”. Furthermore, one announcement item “Registration Open” has been created for agenda “announcement” type. In one embodiment, Agenda Items 401 is selected by highlighting the individual item “Session 1” in the agenda items view 401 then the ADD button in the desired time block 407 is selected or the item “Session 1” can be dragged and dropped in a time block view 407. In either case, once the item has been added to the view, it is removed from the view of available agenda items 401.

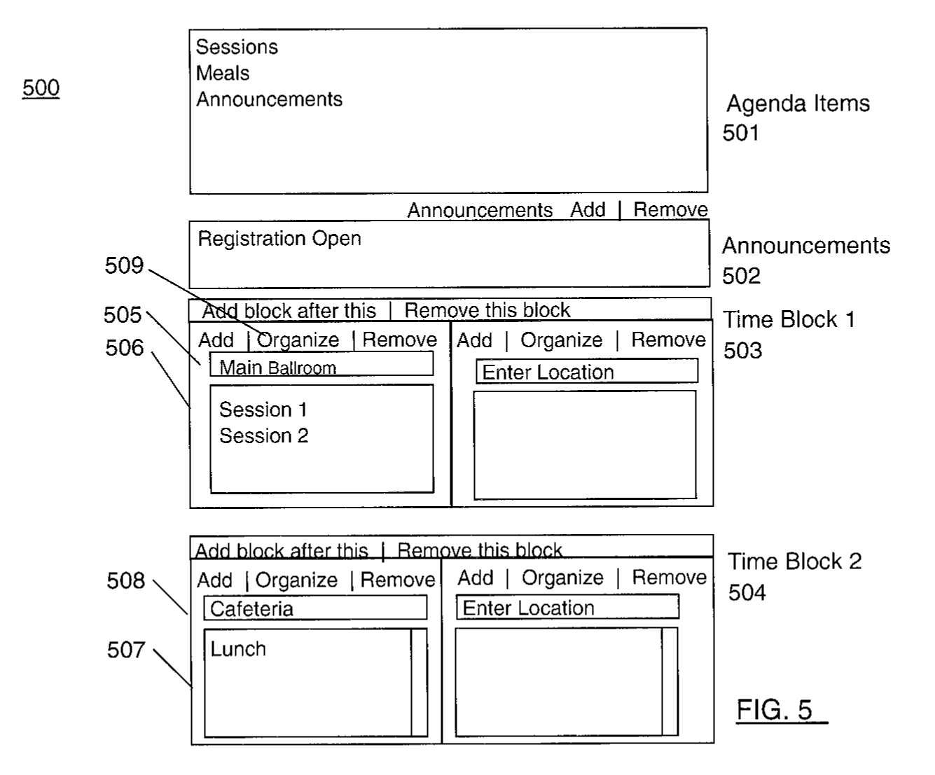

FIG. 5 shows the results of adding elements from the Agenda Items form (501) to the desired time blocks. Since all of the items 501 have been moved to time blocks 503 and 504, only the agenda types are displayed in the agenda items view 501. The announcement “Registration Open” is added to the announcements form (502). In addition, only one track is defined and all agenda items are added to 506. A location “Main Ballroom” is identified (505). The location field 505 508 is preferably entered by the user. However, in one embodiment, the user is prompted for locations by the view 505 wherein the application provides a list of available locations. In another embodiment, attributes of the location can be displayed including floor and room number, seating capacity and the like. The meal item “Lunch” is similarly added to a time block (507) and a location is specified for that activity “Cafeteria” (508).

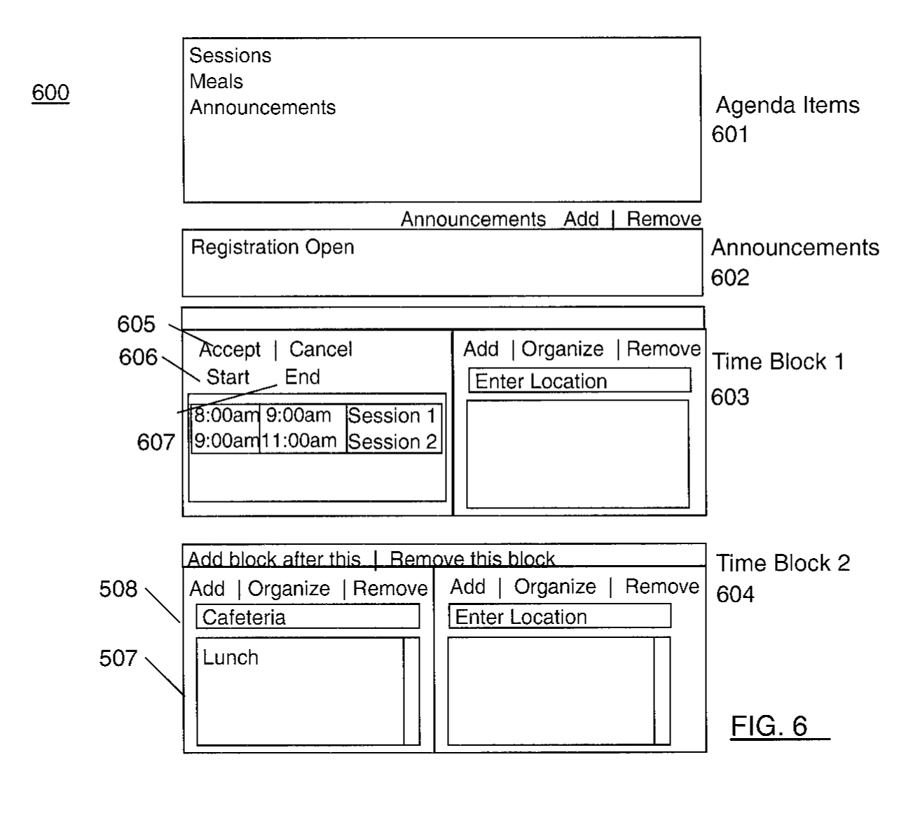

FIG. 6 illustrates the organizing step where times are associated to each of the activities that have been placed in a time block. The organize button (509) in FIG. 5 is selected to initiate the time specification process. Each agenda item in the block 603 is presented with interface widgets to specify the start 606 and end times 607 for each item. Ideally, the system supports the user by only allowing valid times, e.g., start times before end times and seeding the widgets with appropriate times from previous selections, e.g., the start time of the next item would be set to the end time of the previous item. Once the specification of times is complete, the user can accept the edits or cancel the process with the buttons at the top of the items (605). In one embodiment, the time schedule comprises date information as well as time of day. The time and date information is prompted by a variety of means well known in the art including displaying a calendar or timepiece and/or providing initial values and a scroll bar to adjust the values.

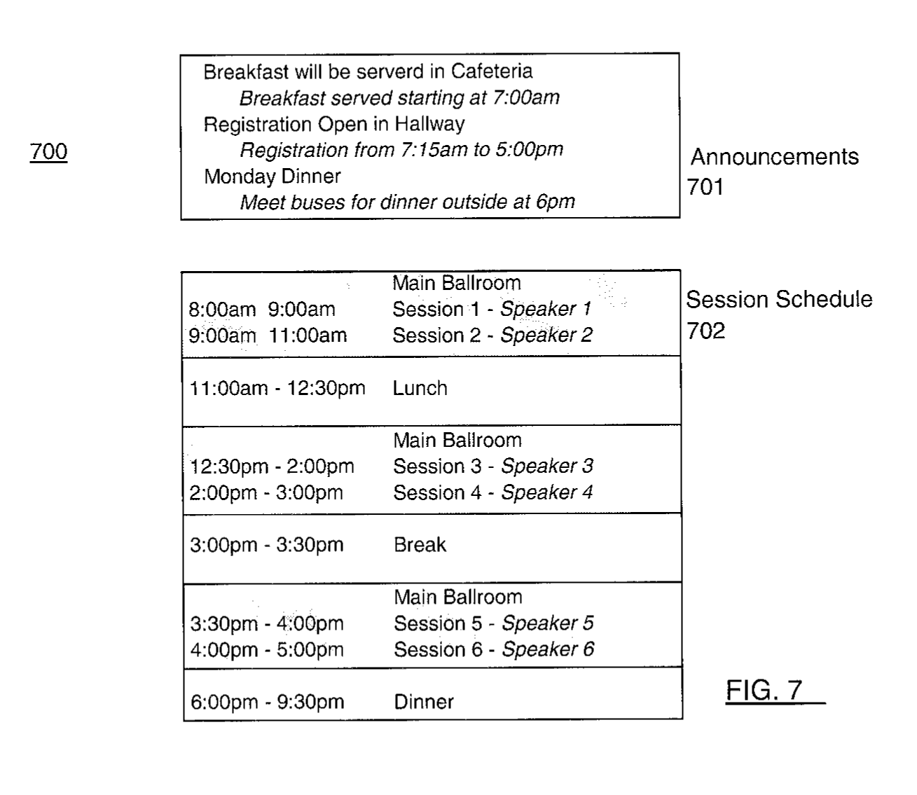

Once all the agenda items have been placed into time blocks and times have been specified, the schedule can be presented in a user friendly form for use by people attending the event. FIG. 7 illustrates a typical final presentation of the schedule. Announcements (701) are presented before the main portion of the session schedule (702). However, at any time during the process, the schedule can be presented with partial information available. In one embodiment Agenda items would be presented in order but without times if the user hasn't gone through the organize step of the process. The presentation 700 is preferably presented electronically by a computer display or a TV display, however mechanical displays may be employed as well as printed copies.

Electronic displays could be accomplished by way of the world Wide Web. Such a display would provide an interactive capability such that a user at a client terminal can select more information by selecting hyperlinks by way of his GUI interface. Thus, the user can select information about “Session 1”, by placing his computer cursor over the word “Session 1” on his computer screen 702 and clicking on it or hitting enter, causing information about the session including electronic document attachments to be displayed. Furthermore, the user can use the electronic GUI window 700 to interactively build his itinerary for attendance at the conference.

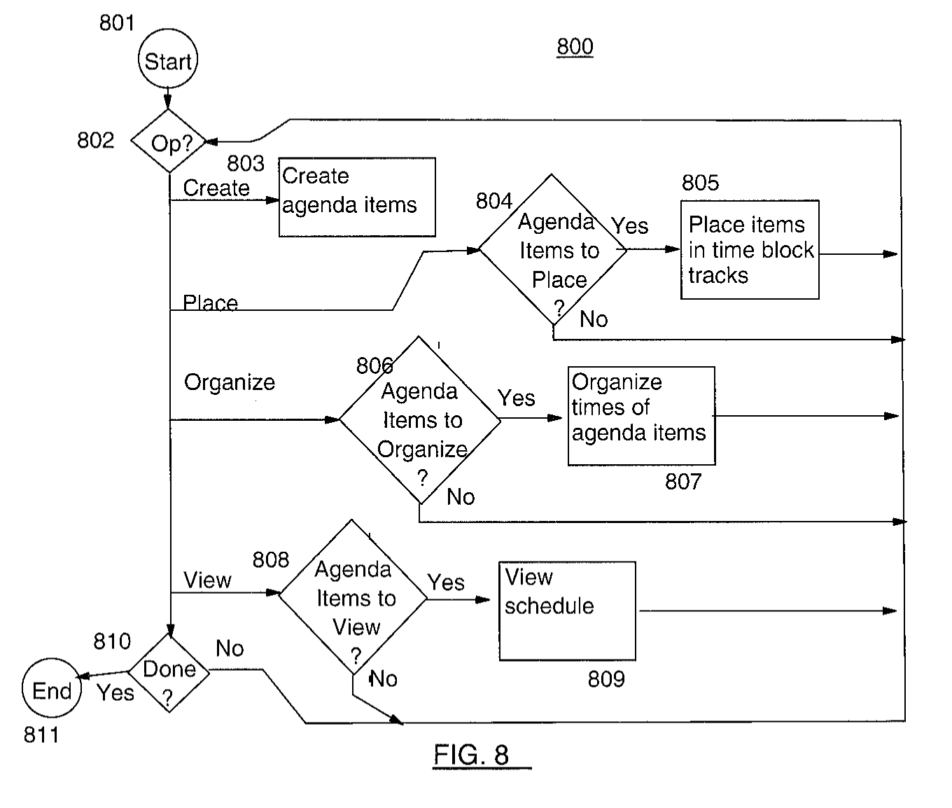

FIG. 8 illustrates an example flow for creating the schedule. First 801 the user chooses the operation. This can be one of create 803, place 804, organize 806 or view 808. When creating 1 or more agenda items (803), items are preferably typed and belong to 1 of a number of categories (types) such as session, meal, announcement, etc. Each agenda item includes data about the session such as title, speaker, abstract, but does not include a location or time. This is specified in a later stage. Then, the user uses the interface shown in FIGS. 3-6 to specify organization, location and time of the schedule. If there exists any agenda items 804, the user continues by selecting agenda items and then adding them to the desired tracks of a time block (805). At this point in the process, the user could display the schedule 809 but no time information would be displayed. If there exists any agenda items in the blocks 806, the user continues by organizing the individual agenda items by setting the times of the agenda items (807). If there are any agenda items to view 808 (have been placed and optionally organized in previous steps), the final step is to display the schedule 809. At any point in the process, the user can move forward or backward in the process skipping steps or leaving steps incomplete. If the user moves to the end 811 of the process and displays the schedule, the system will do the best it can to display the information it has in the schedule layout.

A schedule creator has been built in a web-based, JavaScript-enabled (Ajax) web browser to demonstrate its capability. Content for the event and session items are created in web-based forms input pages.

An exemplary embodiment of the process provides an application to:
1. Create schedule event, or holder, with appropriate meta-data associated with the event, e.g., a conference with a place and time (start and end times).
2. Create the schedule items. No need to assign times or locations at this point in the process.
3. Create sequential and parallel blocks within the event, optionally these blocks can be fixed for the event, e.g., only 2 parallel sessions for the conference.
4. Optionally, name the blocks to indicate, for instance, location of activities within block.
5. Organize the schedule items within the blocks by reordering positions, if necessary, and assigning times to each item.
6. Save the schedule
7. Display the schedule (this step can occur at any time in the process and works with partial information)

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A computer method for developing an event schedule for an event, the method comprising the steps of:
a) presenting a GUI prompt view to a user comprising a list of one or more agenda items;
b) presenting a GUI time block view comprising one or more time block views;
c) responsive to a user first action, associating a first agenda item of the one or more agenda items with a first time block view of the one or more time block views;
d) responsive to a user second action, saving first agenda schedule information received in the first time block view;
e) when more than one agenda items are to be scheduled, repeating steps b) through d) for each agenda item to be scheduled; and
f) presenting to event schedule users, a session schedule comprising a chronological presentation of one or more agenda items, each presented agenda item having agenda schedule information presented therewith, the chronological presentation comprising the first agenda item having entered first agenda schedule information presented therewith, the event schedule users comprising potential attendees of the event schedule.

2. The method according to claim 1, wherein the first agenda schedule information comprises first agenda location information consisting of a location for presenting the first agenda item associated with the first time block view, the location for presenting consisting of any one of a room, a building, a city, a state, a country or an electronic meeting virtual location such as a web page of the world wide web.

3. The method according to claim 1, wherein the first agenda schedule information comprises first agenda time information consisting of a time for presenting the first agenda item associated with the first time block view, the time for presenting consisting of any one of a time-of-day, a day, a month or a year.

4. The method according to claim 1, wherein the first time block view comprises widgets to perform an action, the action consisting of any one of adding a second time block view, displaying a second time block view, removing the first time block view, clearing the first time block view or organizing a time for presenting the first agenda item.

5. The method according to claim 4, wherein responsive to a user third action of selecting the organizing a time widget, time prompts for time for presenting the first agenda item associated with the first lock view are presented, the time prompts consisting of any one of a computer generated time slot, an indication that the entered first agenda schedule information includes an invalid time, an indication that the entered first agenda schedule information includes an invalid time duration or an indication that the entered first agenda schedule information includes time that conflicts with previously entered agenda schedule, the generated time slot consisting of any one of a start time, an end time or a duration.

6. The method according to claim 1, comprising the further step of:
presenting a GUI announcements view;
responsive to a user third action, saving announcement information received in the announcements view; and
concurrently presenting to the event schedule users, the saved announcement information with the presented session schedule.

7. The method according to claim 1, comprising the further step of:
presenting to a creating user, an agenda item view for creating an agenda item, the agenda item view comprising GUI prompts for any one of an agenda item title, an agenda item type, an event identifier, an agenda item contact, an agenda item presenter, an abstract of the agenda item, a description of the agenda item, an electronic attachment widget, an attachment description, a special event requirement, a submit widget or a cancel widget.

8. The method according to claim 7, comprising the further steps of:
responsive to input from the creating user, saving agenda item information meta-data received in the agenda item view for creating an agenda item;
associating the saved agenda item information meta-data with the event having the event identifier; and
presenting information of the saved agenda item information to the user in the presented GUI prompt view of the event.

9. The method according to claim 8, comprising the further step of prompting the user in the presented GUI time block view using information of the entered agenda item information.

10. The method according to claim 1, wherein the first agenda schedule information saved is received in the first time block view out of order with respect to agenda schedule information of other agenda items of other time block views.

11. The method according to claim 6, wherein the GUI prompt view to a user comprising a list of one or more agenda items, the GUI time block view comprising one or more time block views and the GUI announcements view are presented in a single GUI view.

12. A system for developing an event schedule for an event, the system comprising:
a network of client computers;
a client computer connected to said network of client computers, the client computer comprising storage for holding one or more client data files;
wherein the client computer comprises instructions for performing a method comprising:
a) presenting a GUI prompt view to a user comprising a list of one or more agenda items;
b) presenting a GUI time block view comprising one or more time block views;
c) responsive to a user first action, associating a first agenda item of the one or more agenda items with a first time block view of the one or more time block views;
d) responsive to a user second action, saving first agenda schedule information received in the first time block view;
e) when more than one agenda items are to be scheduled, repeating steps b) through d) for each agenda item to be scheduled; and
f) presenting to event schedule users, a session schedule comprising a chronological presentation of one or more agenda items, each presented agenda item having agenda schedule information presented therewith, the chronological presentation comprising the first agenda item having entered first agenda schedule information presented therewith, the event schedule users comprising potential attendees of the event schedule.

13. The system according to claim 12, wherein the first agenda schedule information comprises first agenda location information consisting of a location for presenting the first agenda item associated with the first time block view, the location for presenting consisting of any one of a room, a building, a city, a state, a country or an electronic meeting virtual location such as a Web page of the world wide web.

14. The system according to claim 12, wherein the first agenda schedule information comprises first agenda time information consisting of a time for presenting the first agenda item associated with the first time block view, the time for presenting consisting of any one of a time-of-day, a day, a month or a year.

15. The system according to claim 12, wherein the first time block view comprises widgets to perform an action, the action consisting of any one of adding a second time block view, displaying a second time block view, removing the first time block view, clearing the first time block view or organizing a time for presenting the first agenda item.

16. The system according to claim 15, wherein responsive to a user third action of selecting the organizing a time widget, time prompts for time for presenting the first agenda item associated with the first lock view are presented, the time prompts consisting of any one of a computer generated time slot, an indication that the entered first agenda schedule information includes an invalid time, an indication that the entered first agenda schedule information includes an invalid time duration or an indication that the entered first agenda schedule information includes time that conflicts with previously entered agenda schedule, the generated time slot consisting of any one of a start time, an end time or a duration.

17. The system according to claim 12, comprising the further step of:
presenting a GUI announcements view;
responsive to a user third action, saving announcement information received in the announcements view; and
concurrently presenting to the event schedule users, the saved announcement information with the presented session schedule.

18. The system according to claim 12, comprising the further step of:
presenting to a creating user, an agenda item view for creating an agenda item, the agenda item view comprising GUI prompts for any one of an agenda item title, an agenda item type, an event identifier, an agenda item contact, an agenda item presenter, an abstract of the agenda item, a description of the agenda item, an electronic attachment widget, an attachment description, a special event requirement, a submit widget or a cancel widget.

19. The system according to claim 18, comprising the further steps of:
responsive to input from the creating user, saving agenda item information meta-data received in the agenda item view for creating an agenda item;
associating the saved agenda item information meta-data with the event having the event identifier; and
presenting information of the saved agenda item information to the user in the presented GUI prompt view of the event.

20. The system according to claim 19, comprising the further step of prompting the user in the presented GUI time block view using information of the entered agenda item information.

21. The system according to claim 12 wherein the first agenda schedule information saved is received in the first time block view out of order with respect to agenda schedule information of other agenda items of other time block views.

22. The system according to claim 17, wherein the GUI prompt view to a user comprising a list of one or more agenda items, the GUI time block view comprising one or more time block views and the GUI announcements view are presented in a single GUI view.

23. A computer program product for developing an event schedule for an event, the computer program product comprising:
a storage medium readable by a processing circuit and storing instructions for execution by the processing circuit for performing a method comprising:
a) presenting a GUI prompt view to a user comprising a list of one or more agenda items;
b) presenting a GUI time block view comprising one or more time block views;
c) responsive to a user first action, associating a first agenda item of the one or more agenda items with a first time block view of the one or more time block views;
d) responsive to a user second action, saving first agenda schedule information received in the first time block view;
e) when more than one agenda items are to be scheduled, repeating steps b) through d) for each agenda item to be scheduled; and
f) presenting to event schedule users, a session schedule comprising a chronological presentation of one or more agenda items, each presented agenda item having agenda schedule information presented therewith, the chronological presentation comprising the first agenda item having entered first agenda schedule information presented therewith, the event schedule users comprising potential attendees of the event schedule.

24. The computer program product according to claim 23, wherein the first agenda schedule information comprises first agenda location information consisting of a location for presenting the first agenda item associated with the first time block view, the location for presenting consisting of any one of a room, a building, a city, a state, a country or an electronic meeting virtual location such as a web page of the world wide web.

25. The computer program product according to claim 23, wherein the first agenda schedule information comprises first agenda time information consisting of a time for presenting the first agenda item associated with the first time block view, the time for presenting consisting of any one of a time-of-day, a day, a month or a year.

26. The computer program product according to claim 23, wherein the first time block view comprises widgets to perform an action, the action consisting of any one of adding a second time block view, displaying a second time block view, removing the first time block view, clearing the first time block view or organizing a time for presenting the first agenda item.

27. The computer program product according to claim 26, wherein responsive to a user third action of selecting the organizing a time widget, time prompts for time for presenting the first agenda item associated with the first lock view are presented, the time prompts consisting of any one of a computer generated time slot, an indication that the entered first agenda schedule information includes an invalid time, an indication that the entered first agenda schedule information includes an invalid time duration or an indication that the entered first agenda schedule information includes time that conflicts with previously entered agenda schedule, the generated time slot consisting of any one of a start time, an end time or a duration.

28. The computer program product according to claim 23, comprising the further step of:
presenting a GUI announcements view;
responsive to a user third action, saving announcement information received in the announcements view; and
concurrently presenting to the event schedule users, the saved announcement information with the presented session schedule.

29. The computer program product according to claim 23, comprising the further step of:
presenting to a creating user, an agenda item view for creating an agenda item, the agenda item view comprising GUI prompts for any one of an agenda item title, an agenda item type, an event identifier, an agenda item contact, an agenda item presenter, an abstract of the agenda item, a description of the agenda item, an electronic attachment widget, an attachment description, a special event requirement, a submit widget or a cancel widget.

30. The computer program product according to claim 29, comprising the further steps of:
responsive to input from the creating user, saving agenda item information meta-data received in the agenda item view for creating an agenda item;
associating the saved agenda item information meta-data with the event having the event identifier; and
presenting information of the saved agenda item information to the user in the presented GUI prompt view of the event.

31. The computer program product according to claim 30, comprising the further step of prompting the user in the presented GUI time block view using information of the entered agenda item information.

32. The computer program product according to claim 23, wherein the first agenda schedule information saved is received in the first time block view out of order with respect to agenda schedule information of other agenda items of other time block views.

33. The computer program product according to claim 28, wherein the GUI prompt view to a user comprising a list of one or more agenda items, the GUI time block view comprising one or more time block views and the GUI announcements view are presented in a single GUI view.

34. A computer implemented service for deploying computer readable code to one or more computer systems, the code comprising instructions for execution by a computing system of the one or more computing systems for performing a method for developing an event schedule for an event, the method comprising:
a) presenting a GUI prompt view to a user comprising a list of one or more agenda items;
b) presenting a GUI time block view comprising one or more time block views;
c) responsive to a user first action, associating a first agenda item of the one or more agenda items with a first time block view of the one or more time block views;
d) responsive to a user second action, saving first agenda schedule information received in the first time block view;
e) when more than one agenda items are to be scheduled, repeating steps b) through d) for each agenda item to be scheduled; and
f) presenting to event schedule users, a session schedule comprising a chronological presentation of one or more agenda items, each presented agenda item having agenda schedule information presented therewith, the chronological presentation comprising the first agenda item having entered first agenda schedule information presented therewith, the event schedule users comprising potential attendees of the event schedule.

34. The method according to claim 33, wherein the first agenda schedule information comprises first agenda location information consisting of a location for presenting the first agenda item associated with the first time block view, the location for presenting consisting of any one of a room, a building, a city, a state, a country or an electronic meeting virtual location such as a Web page of the world wide web.

35. The method according to claim 33, wherein the first agenda schedule information comprises first agenda time information consisting of a time for presenting the first agenda item associated with the first time block view, the time for presenting consisting of any one of a time-of-day, a day, a month or a year, wherein the first time block view comprises widgets to perform an action, the action consisting of any one of adding a second time block view, displaying a second time block view, removing the first time block view, clearing the first time block view or organizing a time for presenting the first agenda item.
